(19) United States
(12) Patent Application Publication
(10) Pub. No.: US 2014/0233603 A1
(43) Pub. Date: Aug. 21, 2014

(54) QIKKTEMPS

(71) Applicant: JAMES RICHARD SCHUTT, Vestal, NY (US)

(72) Inventor: JAMES RICHARD SCHUTT, Vestal, NY (US)

(21) Appl. No.: 13/769,532

(22) Filed: Feb. 18, 2013

(51) Int. Cl. G01K 13/00; G01K 1/14

(52) U.S. Cl. CPC G01K 13/00; G01K 1/14
USPC 374/100; 374/208

(57) ABSTRACT

My invention will increase the speed in which tire temperatures can be gathered in the racing industry. Current standard practice allows one temperature reading from a single probe. My device will allow more than one reading simultaneously by employing multiple probes. My invention will be manufactured for adjustability and conformance. Several size variations will be required to meet current and future market demands.

### CROSS-REFERENCE TO RELATED APPLICATIONS

Not Applicable

### STATEMENT REGARDING FEDERALLY SPONSORED RESEARCH OR DEVELOPMENT

Not Applicable

### REFERENCE TO SEQUENCE LISTING, A TABLE, OR A COMPUTER PROGRAM LISTING COMPACT DISC APPENDIX

Not Applicable

### BACKGROUND OF THE INVENTION

This invention centers on the idea and practice of increasing the speed in which tire temperatures can be gathered in a racing environment by utilizing the invented device. Industry standard devices are made by Longcare Racing & Intercomp.
http://www.longacreracing.com/instructions/inst.asp!INSTID=69
https://www.intercompracing.com/Products/MEMORY_TIREBRAKE_PYROMETER_{—}751.cfm

Current technology and practice only allows for one temperature to be gathered at a time. This invention would allow for multiple temperatures to be gathered at the same time.

### BRIEF SUMMARY OF THE INVENTION

This patent application includes the development of a device which enables the user to utilize more than one probe at a time during the tire temperature gathering process. Probe mounting and height adjustability would be engineered into the device to allow user adjustment based on tire profile and width due to the wide range of tires utilized in the racing industry. This invention would enable the user to gather tire temperatures quicker than current standard practice allows which results in an advantage for a racing entity.

### BRIEF DESCRIPTION OF THE SEVERAL VIEWS OF THE DRAWINGS

FIG. 1A General View

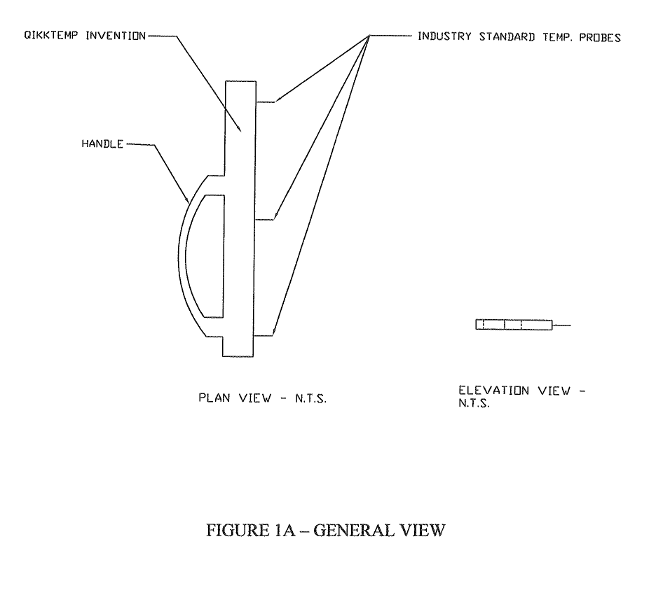

FIG. 2A Practical Use View

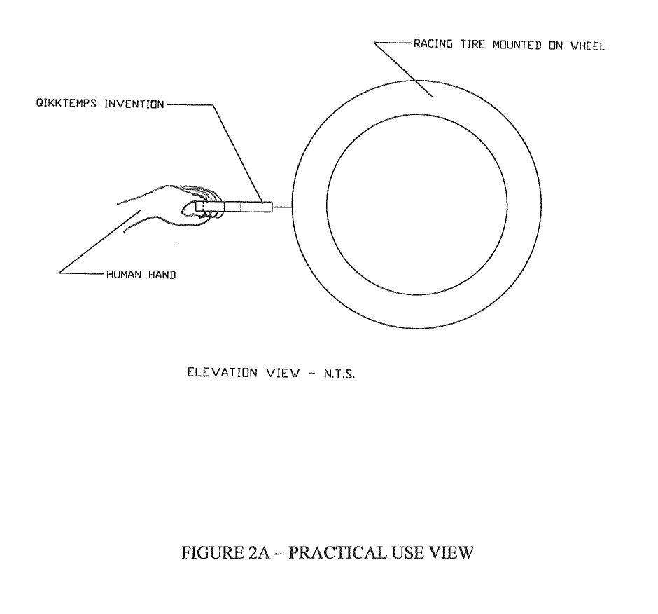

### DETAILED DESCRIPTION OF THE INVENTION

In the industry, business, and operation of amateur and professional automobile racing, various industry standard tools and devices are required to provide individuals with performance information and feedback pertaining to the handling of an automobile. A simple example would be the tire pressure gauge. As a racing automobile increases its speed on the track, the gas pressure in each tire increases. The recorded pressures before and after an on track session are an invaluable piece of information concerning the safety and handling of a racing automobile. The item or aspect this patent application specifically focuses on is utilizing a tool to accelerate the act or process of obtaining the physical tire temperatures from the surface of the tire(s). The standard tool utilized is a single hand held temperature probe which plugs into an electronic reading/recording device. After an on track session, tire temperature information is typically gathered by pushing the probe into three locations on each tire, left edge, center, and right edge separately. Temperature readings are then recorded electronically or written down manually each time the probe is inserted slightly into the surface of the tire. When theses readings are analyzed, specific handling characteristics can be ascertained and adjustments made to the automobile which can affect its handling. Some basic examples would include caster, camber, or tire pressure adjustments. Since industry standard is three temperature readings across each tire, all supplemental information contained herein will focus on the process of gathering three temperature readings simultaneously from a single tire. However my invention could employ any number of probes based on user preference. Since tires begin to cool rapidly once on track activities are complete, it is imperative to record tire temperatures quickly once the automobile comes to a stop. The unique effectives of my invention would greatly enhance this principle. It is also a recognized industry standard, the quicker you can gather tire temperatures the more accurate the readings will be. It is also industry standard that only one person is assigned the task of gathering tire temperatures while utilizing an industry standard device. It's not practical or acceptable to expect or assign several people (utilizing several industry standard devices) the task of quickly gathering tire temperatures from each tire on the vehicle. My invention will allow three probes to be quickly inserted into the tire. The actual probes, temperature readings, and/or recording of such information are not included in this patent's scope. The typical automobile has 4 tires, and current industry standard devices dictates the necessity of taking 12 individual tire temps (three on each tire as explained above). This is a lengthy process in the automobile racing world. Typically once the car stops in pit lane after an on track session, several people are employed to check, adjust, or provide maintenance to the automobile. The person assigned the task of tire temperatures would begin at one corner of the vehicle and proceed around the car stopping at each tire until temperatures are recorded. Temperatures are recorded by holding the temperature probe in one hand and slightly pressing the probe tip into the surface of the tire. While holding the probe in this position, the other hand would press a button on the recording device once the electronic reading of the temperature was realized. This would record the tire temperature at that location. This process usually takes a few seconds before moving onto the next position on the tire. Temperatures are usually taken from left to right or right to left across a tire depending on the configuration of the electronic device the probe is plugged into. This process would continue until temperatures from all tires were known. My device would operate the same but allow the tire temperatures of one tire to be taken simultaneously before proceeding to the next tire. Once the probes are adjusted properly, the handle would be held and then the device would be pushed until all probes are slightly inserted into the surface of the tire as described above. The other hand would then activate the recording device in the same manner as outlined above which would result in the recording of three temperatures simultaneously. The electronic programming or hardware required for more than one probe to simultaneously read and or record tire temperatures is not included in the scope of this patent. If compared to the conventional, industry standard one probe devise, my temperature readings of four tires (twelve individual temperature readings) will be complete while the one probe devise only has one tire complete (3 individual temperature readings). This obviously greatly reduces the time required in completing the industry standard tire temperature process currently available today. My invention will be produced out of a light metal, possibly aluminum due to its ease of machining, cost effectiveness, and relative strength. Although any material could be utilized (including plastics) to produce an acceptable working device aluminum seems a logical choice. Known and standard mechanical hardware will be utilized to mount the temperature probes to the invention which will allow for adjustability as explained previously. It is conceivable various sizes or scaled versions of the invention will be necessary due to the wide range of tire applications in today's and future markets. It is also recognized that a single sized device will not provide adequate room for probe adjustment for all applications. For these reasons this invention specifically includes a device of any material composition, size, and shape which will produce the functionality and end result described herein.

1. A hand held device mechanically capable of securing more than one tire temperature probe in a manner that allows the user to simultaneously insert the tire probes into a tire.

2. A device manufactured, made, or produced by any means and materials which allows the user to employ more than one tire temperature probe while in the act of gaining or taking tire temperature readings.
